(19) United States
(12) Patent Application Publication
(10) Pub. No.: US 2009/0207511 A1
(43) Pub. Date: Aug. 20, 2009

(54) ASSEMBLY FOR ADJUSTING AN OPTICAL ELEMENT

(75) Inventors: Armin Schoeppach, Aalen (DE); Manfred Steinbach, Jena (DE); Thomas Schletterer, Stadtroda (DE); Ernesto Lopez-Real, Jena (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/914,055

(22) PCT Filed: May 9, 2006
(86) PCT No.: PCT/EP2006/004337

§ 371 Date: Aug. 8, 2008

Related U.S. Application Data
(60) Provisional application No. 60/679,687, filed on May 9, 2005.

(51) Int. Cl. G02B 7/02

(52) U.S. Cl. 359/822; 359/811

(57) ABSTRACT

An assembly for fixation or adjusting of an optical element (1) with, regard to an outer mount or support (4) wherein the optical element (1) is alignable with regard to a structure of the optical arrangement, particularly the objective structure or the objective barrel, having an optical axis or with regard to neighbouring mounts by means of an adjusting arrangement, is characterized in that the adjusting arrangement comprises at least an elastic means (9), particularly a spring, an elastic rod or stick, an elastic tape or an elastic gear wheel or an elastic gear box by which a force or a torque is applicable to the optical element (1). The assembly is particularly suitable for use in a microlithographic exposure apparatus. In some embodiments an intermediate ring (27) positioned between the optical element (24) and the outer mount or support (26) is used to reduce deformations.

The present invention pertains to an assembly for fixating or adjusting of an optical element with regard to an outer support wherein the optical element is alienable with regard to a structure of an optical assembly having an optical axis, particularly to a structure of an objective, or with regard to neighbouring supports by means of an adjusting arrangement.

Optical elements have to be defined in very stable positions in holders or supports and may not experience any change of position or deformation after these components have been combined with other structural elements. This is particularly required in high performance optics as used in micro lithography. Nethertheless mounting and process steps requiring a change of position cannot be avoided. Regularly, these changes are corrected by tunable intermediate steps; these steps, however, implicate an iterative sequence of mounting, demounting, correcting and renewed mounting steps and often permit only limited correction restricted by the degrees of freedom. A robust and simple adjusting mechanism comprising the barrel and the support of the element would be desirable. A last correcting step regarding all six degrees of freedom should be realized without a step of demounting; in the same time all requirements of an optical assembly comprising at least a single optical element should be met as are stiffness and decoupling of deformation.

From US 6 229 657 B1 an assembly of an optical element and a mount is known, in which the optical element is coupled by means of numerous lugs to a rigid intermediate ring, which itself is coupled by adjusting members or passive decouplers to the mount for connection to a housing and/or a further mount. Actuators are provided that

From US 2002/0163741 an optical element holding apparatus is known that comprises holders and actuators positioned tangentially with regard to a lens. An assembly for positioning an optical element in an optical assembly, particularly in a projection objective for semiconductor lithography, is described in EP 1 245 982 A2 which is connected to an outer support by three bearings positioned at the circumference of the optical element. Connecting members in form of leaf springs are provided that bring movements generated by manipulators positioned in the support to the optical element.

From US 2005/0002011 A1 a support mechanism and an exposure apparatus comprising the support mechanism are known. The support mechanism for supporting an optical element includes a first support member for supporting the optical element and a second supporting element coupled to the first support member via an elastic member, and a forcing member for applying a force to the elastic member. When the forcing member applies a force to the elastic member, a position and/or an orientation of the optical element are adjustable, or the relative positions between the first and the second support members are changed. The elastic member deforms in a radial direction of the optical element or about a rotational axis perpendicular to both a radial direction of the optical element and a direction into or parallel to the optical axis of the optical element.

The technology shown in FIG. 3 of this document permits pressing on a small bridge connecting two flat springs 222 and 224 by means of a bulbar part 232 of a compression member or micrometer screw 230 and thereby to elastically deform a lens L held by a support member 210. An adjusting of the lens L in two degrees of freedom is realized at the same time. By coupling of these two degrees of freedom compulsory forces are realized that partially have to be taken by both a lens barrel and the support member 210.

From US 2003/0234918 A1 adjustable soft mounts in a kinematic lens mounting system are known. A mounting system for mounting an optical element such as a deformable lens for use in a lithographic exposure apparatus employs a plurality of adjustable soft mounts to support it and apply vector and moment forces at its peripheral portions so as to correct its shape. These adjustable soft mounts each have an elastic member such as a coil spring, a cantilever plate spring or a torsion spring and a force-adjusting member such as an adjusting screw or bolt that varies the force applied by the elastic member to a peripheral portion of the optical element. The soft mounts are less rigid than position defining mounts that support the optical element at a desired portion.

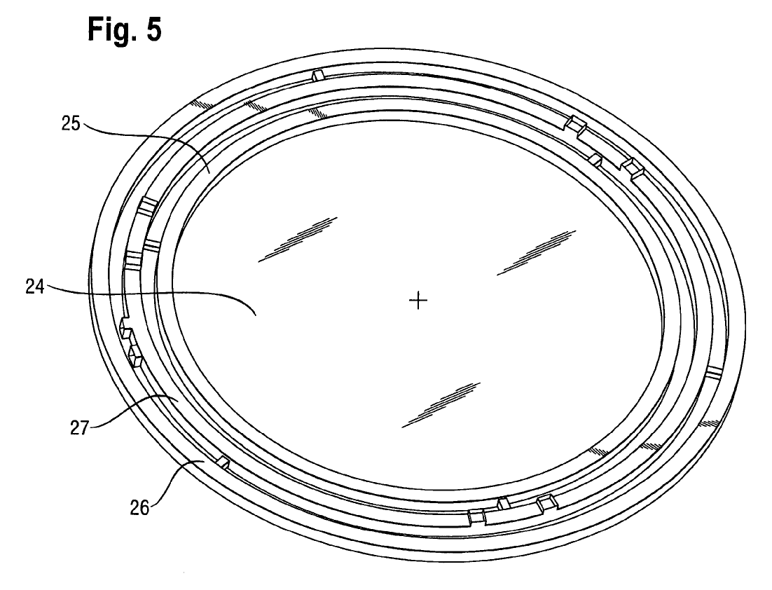

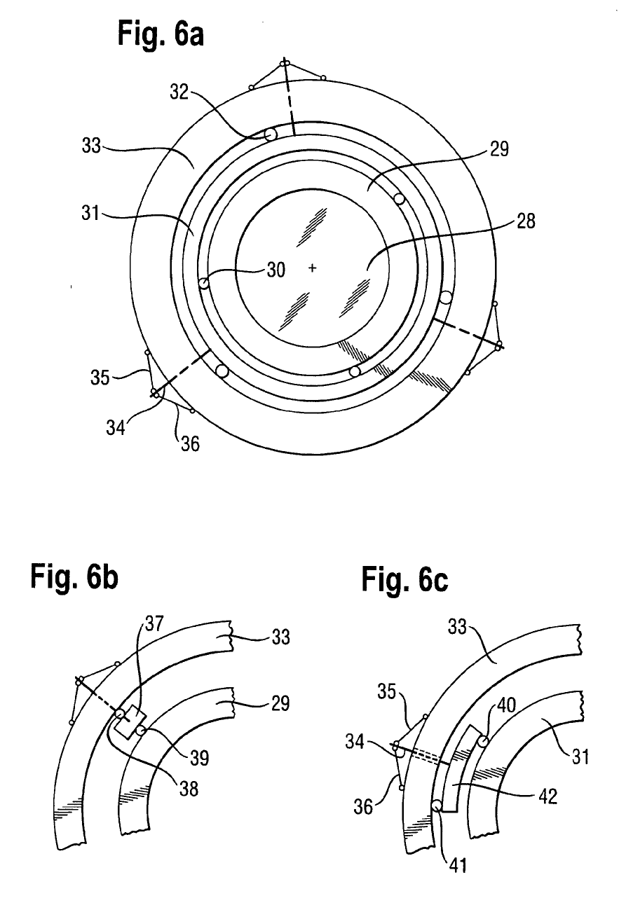

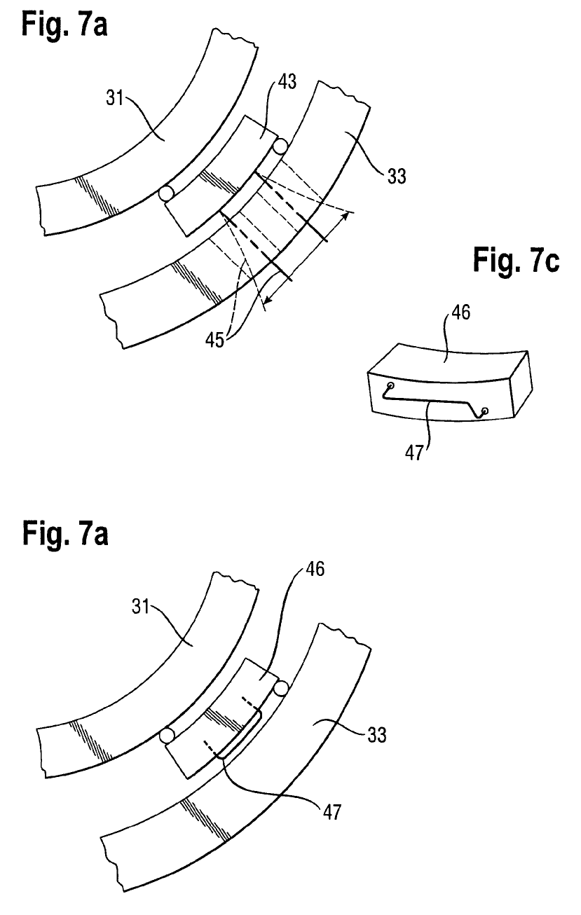

From this document, it is principally known to provide tangentially rigid mounting structures having a constraint in one direction, i. e. the tangential direction, and allowing five degrees of freedom associated with two direction of forces (vector forces) and three direction of torques (momentum forces) (example shown in FIG. 6). In another embodiment (FIG. 7) according to this document, a soft mount is realized by a low-stiffness spring having one end fixed to a peripheral point of an optical element or its flange, so as to apply an upward force thereonto.

According to FIG. 11 of this document, a rigid mounting structure is constrained in the tangential and axial directions. An actuator comprised of a static adjustor, a soft spring and a voice coil motor is provided to the clamping structure. Static moment forces can be applied to the structure through off-axis mechanisms such as leaf springs and adjustors wherein dynamic adjustments may be added to these mechanisms.

It is an object of the present invention to improve an optical assembly that positioning of the optical element is achieved in a simple manner.

According to the invention this object is attained by an assembly characterized in that the positioning arrangement comprises at least a single elastic or resilient means that shifts or moves the optical element in two degrees of freedom or two directions independently by exerting a force or a torque on a flange of the optical element or a holder or a support enclosing the optical element.

According to the present invention “positioning” comprises adjusting of an optical element in a controlled way like with an open or closed loop control and comprises also a single adjustment for the single calibration of the system.

According to the present invention the member exerting a force and/or a torque on the flange of the optical element or on a support holding the optical element may be entirely elastic or may be comprised of a resilient material that partially is elastic and partially is plastic. According to the invention the use of a resilient member may be appropriate when the optical element needs to be positioned in a unique positioning operation.

According to the invention the principle is used that the work generated by a force applied to a work arm of a lever formed by an elastic body, for instance a stick of leaf steel, is only partially transformed to a work exerted along the direction of the load arm, but is, for the other part, needed for distorting of the work arm, and, if the load arm likewise consists of an elastic material, is also needed to distort the load arm. Therefore a considerable share of the work exerted by the force has to be used for distortion if it is intended to reposition the load arm. Therefore, according to the invention at least one of the work arm or the load arm consists at least partially of an elastic material.

For adjusting or for a single positioning of an optical element, particularly a lens, a mirror, a reticle or an aperture, or the like, this effect is used to enlarge the reduction of an external influence to adjust or position an optical element. If, for instance, a rigid work arm of the state of the art having a lever distance of 5 mm leads to a movement of the load arm of 5 μm, this implies a reduction of 1:1000, and therefore a work arm having a length of thousand times the length of the load arm; such a reduction is realized by a work arm by far smaller according to the invention as a part of the work is always spent to distort the work arm and/or the load arm.

In reversed application of this principle, the same application of a force applied to a work arm produces, according to the elasticity of the work arm and/or the load arm a correspondingly weaker and therefore more precise movement of the load arm. For estimating precisely the movement of the load arm it is prerequisite to know exactly the elasticity value that—at least over a wide range—is many times a constant or has a known characteristic line as a function of the distance.

The teaching of the present invention explained above with respect to the use of a lever as an adjusting means is applicable to all means for transferring a force or a torque directly on a flange of an optical element or on an inner support or inner ring supporting the optical element. Thereby gear boxes with gear wheels equipped at least partially with an elastic material, rolls together with elastic tapes, springs in form of helical or spiral springs, or any other means appropriate to receive deformation energy.

According to the teaching of the present invention two forces or two torques or a combination of one force and one torque act on a single element or point of a hinge.

Advantageous embodiments of the invention are represented by the depending claims, the description and the drawings.

According to the present invention an assembly for positioning of an optical element with respect to a mount wherein the optical element is positionable by a positioning arrangement is provided. The assembly is characterized in that the positioning arrangement comprises at least a single elastic or resilient means that shifts or moves the optical element in two degrees of freedom or two directions independently by exerting a force or a torque on the optical element itself, on a flange of the optical element or a holder or a support enclosing the optical element.

According to this invention “to shift” means a linear motion whereas “to move” comprises a linear or a rotational motion.

Further, the assembly may be characterized in that the holder or the support comprises at least a single isostatic mount to which a force or a torque is applied by the elastic means wherein the isostatic mount is adjustable in at least two degrees of freedom.

Preferably, the at least one isostatic mount is a bipod or a bipod structure.

Preferably, the elastic or resilient means comprises reduction means, particularly a spring, an elastic lever or rod, an elastic tape or belt, an elastic gear-wheel or an elastic wheel.

In an advantageous embodiment the elastic means is moveable or shiftable in each of the two directions or degrees of freedom by two separate means, particularly by two piezoelectric or electostrictive actuators or by two motors or by two pneumatic or hydraulic means.

Further it is advantageous if three elastic means are provided that each are shiftable or moveable in two directions or two degrees of freedom.

Preferably the assembly is characterized in that the three elastic means are positioned at angles of substantially 120° apart from each other and wherein the acuators are positioned at angles of between 60° and 120° between them, preferably at 90° between them.

Further, the assembly may be characterized in that the elastic means or each of the elastic means is movable or adjustable by means of at least one screw, particularly by means of a micrometer screw.

In a further embodiment the at least one screw is borne in an outer ring or in an interstitial or intermediate ring.

In another embodiment the interstitial ring is coupled in that way to the outer ring that the interstitial ring is statically defined.

Preferably, the assembly is characterized in that the interstitial ring is coupled to the outer ring by means of spring elements.

In a further embodiment the spring elements are distributed over at least substantially equal distances from each other between the interstitial ring and the outer ring.

In another advantageous embodiment the spring elements are stiff.

It is advantageous if the optical element is supported by an inner holder and if the force or the torque to adjust the optical element is applied to the inner holder.

Preferably, the inner holder is connected to an outer mount by an intermediate part or ring wherein at least a single adjusting means is applied to the intermediate ring. As a rule, three adjusting assemblies positioned at a distance of 120° are applied to the inner ring to ensure a possibility of adjusting in all six degrees of freedom. If, however, an adjustment is needed in less than six degrees of freedom, less than three adjusting assemblies may be provided.

In an advantageous embodiment the at least one intermediate part is constructed in that way that it comprises a first bearing member connected to the inner support, an intermediate element and at least a positioning or adjusting means by which a force or a torque to adjust or readjust the optical element by an elastic means, applied to the intermediate element is applicable to the optical element from the intermediate element.

Hereby, advantageously, an elastic rod or stick serving as a work arm of a lever, an elastic tape or belt for transmitting a torque by means of at least one roll, an elastic gear wheel in a reduction gear box for transmitting of a torque or another elastic means, particularly a spring, preferably a spiral spring, or an elastic tape or belt for transmitting a force or a torque on an intermediate element is provided and therefore serves as an elastic means to which a force or a torque is applied.

Preferably, an intermediate element consists of a rigid or at least a less elastic material than that forming the means that applies the force or the torque.

Together with the adjusting means at least a second bearing member is used that is connected to the outer holder or support.

Advantageously, each adjusting means comprises at least an elastic lever fixed by one of its distal ends at the intermediate element to exert a force or a moment on the intermediate element or to rotate it.

For instance, a single lever is provided that, with regard to the optical element, is aligned in any direction. However, there may be several levers, that may be lifted and lowered in the direction of the optical axix of the optical element. Also a rotational movement of the levers is possible whereby the levers may undergo a torsion at the same time. The rotational movement of the levers may take place in the area of the optical element.

The lever may be adjusted in a preferable way, for instance, be rotated and/or be adjusted in axial and/or radial direction.

For a unique positioning and fixation of the assembly it is sufficient if the at least one lever is fixated with its second distal end at a fixation element, especially by means of a positioning element have a hole at a predetermined position (Lochmaske). It is to understood that by exchange of such elements having a hole or a plurality of holes that are, for instance, fixed at the outer support, other positions of the inner support and therefore of the optical element may be adjusted. In the alternative, an actuator may be provided to change the position of the embodiment.

Advantageously, the actuator comprises an electromagnetic, an electrostrictive, a pneumatic, a hydraulic or a mechanical means for actuating the actuator.

In an advantageous embodiment of the assembly the first bearing members are positioned at least partially in recesses or grooves of the inner support.

In a corresponding way the second bearing members may be positioned in recesses or grooves of the outer support.

Preferably, the second bearing members are each embodied as cardanic hinges to permit tilting of the intermediate member in all directions of space.

In an advantageous embodiment of a cardanic hinge, the second bearing members each comprise leaf spring hinges or a pair of metal plates

Advantageously, it may be provided that two of the thin metal plates extend in a tangential or axial direction under an acute or an obtuse angle with regard to the intermediate element in an

In the same way it is advantageous if the first and/or the second bearing elements are embodied as solid body hinges, preferably as leaf springs.

Additionally, it is provided advantageously, that bearing elements or hinge elements, preferably leaf springs, comprise an intermediate member in form of a cross to decouple radial torques or moments.

The intermediate parts may be produced in different ways, for instance, in that the intermediate parts are produced from at least one basic element by cutting out the hinges in the at least one basic element.

In the same way the intermediate parts may be generated by eroding of a original body.

In a special embodiment of the invention it is provided that intermediate parts are embodied as ring segments or as a closed ring. In the same way, it is imaginable that the intermediate parts or elements are embodied at least partially as rings or ring segments or that they are connected by such.

In an advantageous embodiment of the invention the intermediate ring or the ring segments are fixed by at least a first bearing element at the inner ring and at least by a second bearing member at the outer ring.

The invention also pertains to an embodiment for fixation and adjustment of an optical element with regard to an outer support, wherein the optical element is alignable with regard to a structure of an optical assembly, especially to an objective structure, having an optical axis or with regard to neighbouring mounts, adjustable by means of an adjusting means.

Such an embodiment is characterized in that the adjusting means is embodied by an intermediate ring positioned between the optical element and an outer support or holder.

Also in this embodiment of the invention it is advantageous if the optical element is borne by an inner mount and if the intermediate ring is borne between the inner mount and the outer mount.

Preferably, adjusting elements are positioned at the intermediate ring that may be generated by eroding the intermediate ring.

An embodiment of the invention proves as advantageous according to which the adjusting device comprises at least a single optical element that is installed tensed up in the intermediate ring or in the ring segment and that applies two forces and/or torques being in equilibrium with regard to each other.

Advantageously, the adjusting device comprises at least an elastic element to apply a tensing up force or a torque against the outer ring or the intermediate ring.

The torque or the force is exerted preferably by at least a single reduction means on the intermediate ring, preferably by a projection having the form of a block.

The invention is related also to an assembly for fixation or adjustment of an optical element with regard to an outer mount or support wherein the optical element is alignable with regard to a structure of an optical arrangement, especially an objective structure, having an optical axis or with regard to neighbouring mounts by means of at least an adjusting arrangement.

Hereby, the assembly is characterized in that the at least one adjusting arrangement comprises at least one elastic element to which a force or a torque is applied.

In an advantageous embodiment of the assembly the optical element is supported by an inner support.

Further, the invention is also related to a projection exposure apparatus for micro lithography. The projection exposure apparatus is characterized in that the projection objective is equipped with at least one assembly for adjusting or positioning of an optical element as described above.

The invention will hereinafter be explained in more detail through examples of embodiments with references to the drawings, wherein:

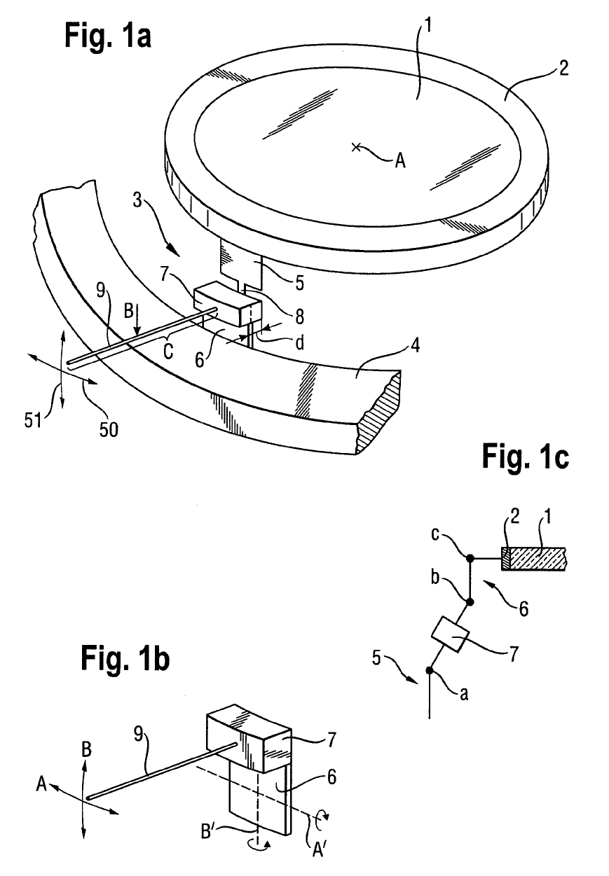

FIG. 1a is a perspectivic top view on an optical element supported by an inner support wherein the optical element is borne in an intermediate part having two adjusting means,

FIG. 1b shows a detail of FIG. 1a,

FIG. 1c is a schematic view on elements of FIG. 1a,

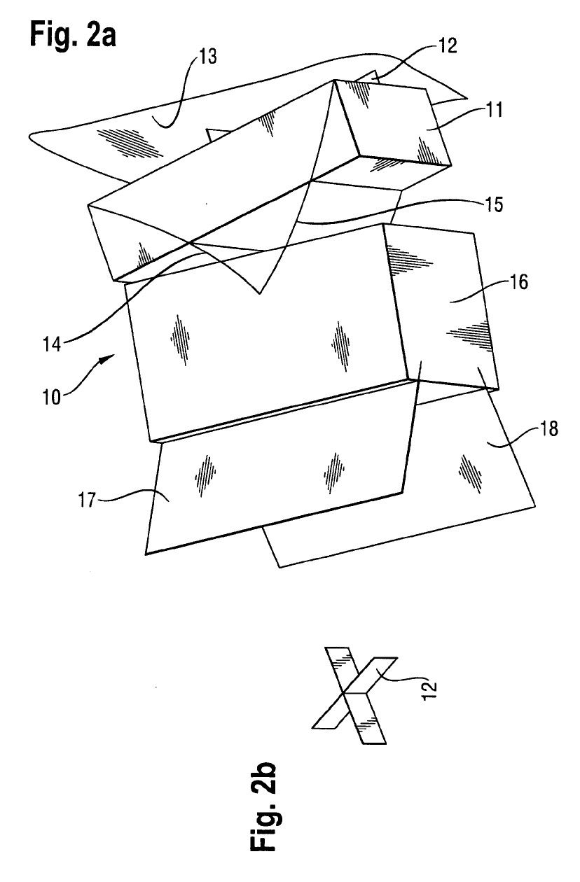

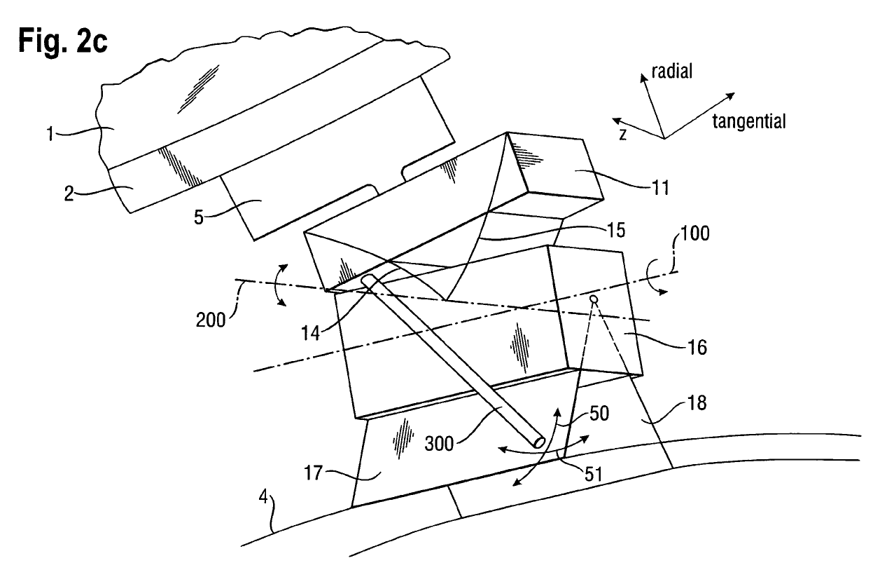

FIG. 2a-c are perspective views of a bearing element arranged between an outer support and the intermediate part, enlarged,

FIG. 3 is a section of an inner support and an outer support having an intermediate part arranged between them according to FIGS. 2a, b,

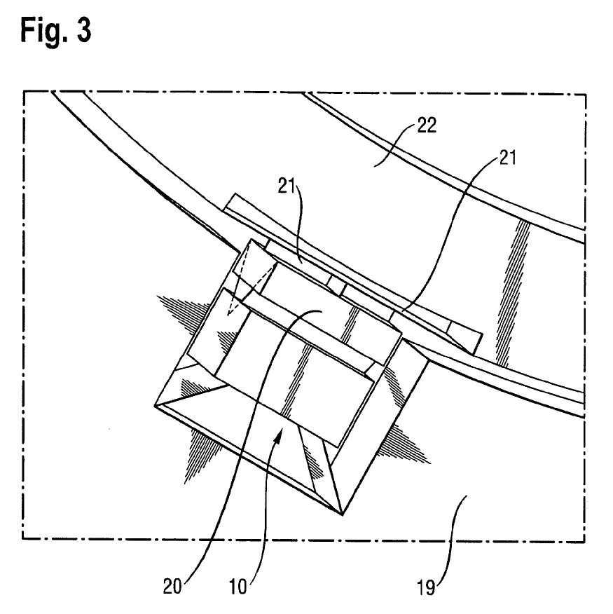

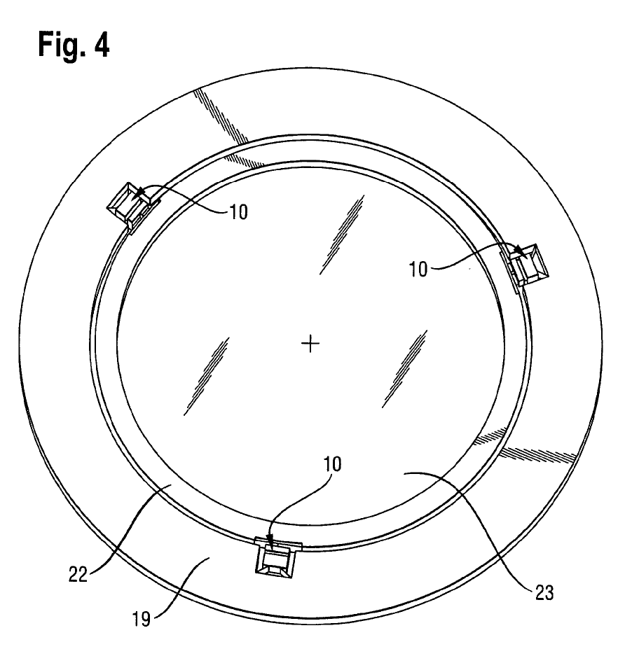

FIG. 4 is a top view of an optical element arranged between an inner support and an outer support comprising three intermediate parts

FIG. 5 is a view of an intermediate part,

FIG. 6a is a view of an alternative of an elastic means for adjusting of an optical element positioned in an inner ring,

FIGS. 6b, c are detail views of FIG. 6a, enlarged,

FIG. 7a-c are further detail views of intermediate parts,

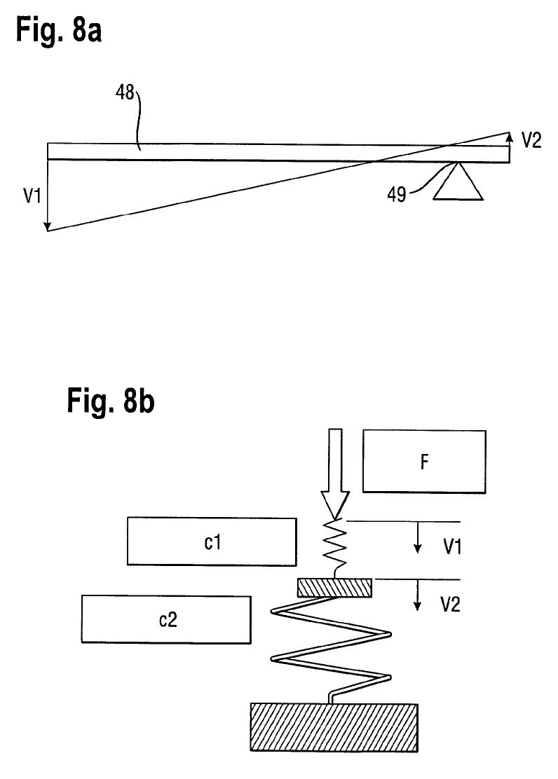

FIGS. 8a, b shows the concept of the invention of a reduction controlled by rigidity compared with the lever principle according to the state of the art,

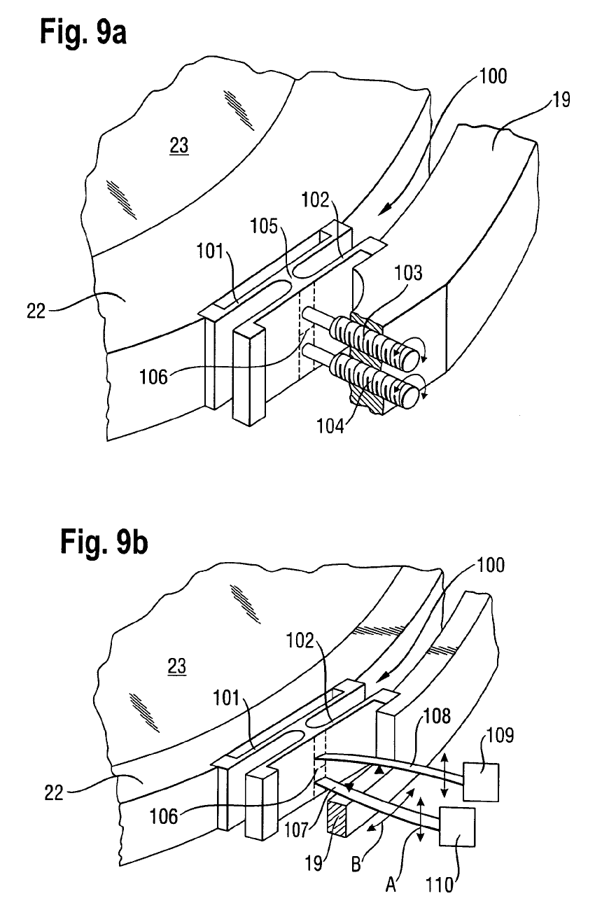

FIGS. 9a, b a schematic sectional view on an adjusting mechanism comprising two micrometer screws or two levers for adjusting an optical element, and

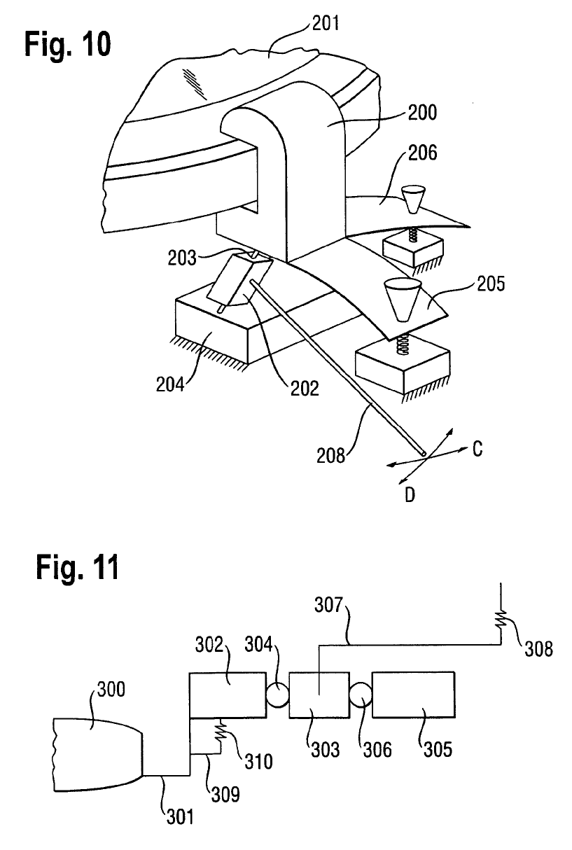

FIGS. 10, 11 other embodiments comprising adjusting mechanisms.

An optical element 1 (FIG. 1a), for instance a lens or a mirror, through the center A of which an optical axis a extends in the axial direction is supported in an inner ring or inner mount 2. The position of the optical element 1 with regard to the inner mount 2 and an outer mount 4 may be adjusted by an adjustor comprising an intermediate part 3 for a single time or may be changed repeatedly. The assembly preferably comprises three intermediate parts 3 that are arranged symmetrically between the outer circumference of the inner mount 2 and the inner circumference of the outer mount 4.

Each intermediate part 3 comprises a first bearing element 5 connected to the inner mount 2, a second bearing element 6 connected to the outer mount 4, and an intermediate part 7 positioned between the bearing elements 5, 6, for instance being embodied as a solid block. The bearing elements 5, 6 each consist of a thin elastic material and constitute, together with the intermediate part 7, a statically defined bearing of element 1. Bearing element 5 has lateral grooves that constitute a small bridging element or catwalk 8 connecting element 5 to the intermediate element 7 and ensure a sufficient flexibility or suppleness of bearing element 5 in the direction of its radial or tangential axis.

Bearing element 6 (FIG. 1b) is an elastic element that is rotable in two degrees of freedom. It may be replaced by a hinge arrangement as shown in FIG. 2. The elastic element 6 is shown again in FIG. 1b wherein rod 9 having two defined rotational axes A and B exerts a rotation of element 6 in the direction of axes A′ and B′ of element 6. Two rotational degrees of freedom are exerted independently of one another. Each rotational degree of freedom may be converted to a translational degree of freedom by means of levers or arrangement of levers connected with each other by hinges.

Therefore two rotational or two translational degrees of freedom or a combination of a rotational and a translational degree of freedom are realized independently by the present invention.

Bridging element 8 comprises a point of attack wherein two forces or two torques or a combination of a force and a torque act on the support 2 or directly on the optical element 1 if there is no support. According to FIG. 1, bridging element 8 is a link between the support 2 or the optical element 1 and the adjusting means. Preferably, the optical element 1 is held isostatically by three bearing points, eventually by means of an inner ring or an inner support. This means, that by each adjusting arrangement two degrees of freedom are adjusted independently.

At intermediate element 7 an elastic stick 9 extending in radial direction with respect to the optical element 1 is fastened that serves as adjustor. When a torque applied to stick 9 is exerted on intermediate part 7 in direction of arrow B the intermediate part 7 is moved and causes a bending of bearing element 6.

The stick 9 has a length C that is a multiple of a length d between the point of attack of stick 9 within block 7, i. e. at its center, and the contact line of catwalk 8 at block 7. The relation C:d constitutes a regular reduction relation between the length of the work arm and the length of the load arm. As, however, stick 9 is made of a highly elastic material, for instance a spring steel, the relation of reduction is increased by far, for instance by a factor 100. By a fixed expense of force a much smaller and therefore much more sensible adjustment is in axial and tangential direction is realized than would be possible according to the state of art using a rigid or at least substantially rigid positioning means.

In a schematic view (FIG. 1c) it is shown how elements 5 and 6 are moved when element 7 is bent by means of stick 9 in direction 51. It is to be remarked that both elements 5 and 6 contain hinge points a, b and c. Thereby it is possible to exert a considerable change of the position of optical element 1 in the direction of the optical axis (z-axis) without exerting any considerable movement in radial direction.

In another embodiment (FIGS. 2a, b) an intermediate part 10 appropriate for insertion between an inner mount and an outer mount comprises a block 11 that constitutes an intermediate part wherein an attacking means for transmission of a torque or of a force onto block 11 attacks the block 11, and in that way the inner mount. Block 11 is connected directly to an inner mount or to a thin metal plate 13 that belongs to the inner mount by means of a short torsion stick or an element 12 in form of a cross. This arrangement constitutes a first bearing element; the inner ring positioned at three bearing points has a bearing statically substantially or approximately defined.

On its other side, block 11 is linked to another element 16, that has the form of a block, by means of two metal plates 14, 15 arranged under an obtuse angle with regard to each other. Element 16, for its part, is connected to an outer mount by means of two metal plates 17, 18 inclined with regard to each other. Metal plates 14, 15, together with element 16 and metal plates 17, 18, constitute the second bearing element that constitutes a cardanic hinge or joint and that permits tilting of the inner mount in all directions of space at three bearing positions. At block, 11 a torque may attack in the same way by an elastic stick as shown by FIG. 1.

The intermediate part or adjusting means 10 shown in FIGS. 2a, b is, for instance, inserted in a recess of outer mount 19 (FIG. 2c) in order to tilt block 11 by means of a stick 20 as described hereinafter. Elements 12 (FIG. 2a) and 21 (FIG. 3) are another embodiment of a statically defined bearing comprising the elements 5 and 8 as shown by the embodiment of FIG. 1.

Elastic element 6 of FIG. 1a may be replaced by a “cardanic” arrangement of hinges as shown in FIG. 2c. Two cardanic axes 100 and 200 are provided wherein axis 200 may be—but not necessarily—rectangular with respect to axis 100. A rigid or an elastic or flexible lever 300 may be fixed at the element 12 whereby a recess or an excavation in element 16 is necessary to permit a free movement of lever 300. When lever 300 is activated in the direction of the optical axis, 51 part 11 and part 16 exert a tilting movement about axis 100. When lever 300 is activated in direction of axis 50 part 16 remains in its rotational position whereas part 11 rotates about its axis 200. Thereby ring 2 and optical element 1 is positionable by two axes 100 and 200 of rotation, i. e. an axial and a tangential rotation. The position of axis 100 is defined by the arrangement of holding elements 17 and 18.

Generally, an elastic element 6 rotatable in two degrees of freedom as shown in FIG. 1 may be replaced by a hinge arrangement comprising two defined rotational axes as shown by FIG. 2a -c.

Adjusting means 10 (FIG. 4) are distributed in triplicate over the circumference of the outer support 19 to permit a positioning, moving or shifting of the lens 23 or another optical element as a mirror or a reticle borne in the inner support 22. Therefore, bearing an optical element in the centre of a concentric support system according to the invention permits to adjust an optical element in all 6 degrees of freedom wherein each degree of freedom is adjustable independently of the others. Coupling of two or more degrees of freedom as disadvantageously taught by the state of the art is avoided, at least substantially.

Further embodiments (FIGS. 6a, b, 7) show an extended principle of the invention wherein the intermediate part 7 of FIG. 1 or intermediate part 11 of FIGS. 2a -c, respectively, are embodied by a ring having a plurality of segments or having a closed form.

The last form is shown by FIGS. 5, 6a where an optical element 24 is borne in an inner mount 25. Thereby, an intermediate ring 27 is positioned between inner mount 25 and outer mount 26. An advantage of such a system consists in that three components, an inner ring or inner support 25, an interstitial or intermediate ring or support 27 and an outer ring or barrel 26 bear an optical element 24 and thus compulsory forces, e. g. acting on the outer support 26, are reduced; and therefore the deformations.

Appropriate adjusting arrangements are shown by FIGS. 7a, b, c. These adjusting arrangements comprise a single or plural elastic means that are embodied by thin spring sticks or torsion springs that may be bent, for instance, in form of a U, or that are embodied by a thin wire.

In the embodiment shown in FIG. 6a an optical element 28 is borne in an inner mount or in an inner ring 29 that, on its part, is arranged in an intermediate ring 31. This ring 31 is borne in an outer support or an outer ring 33 by means of second bearing elements 32. The outer support 33 is borne in the barrel of the objective by means of flexures or elastic elements 34 that may be embodied by wires. To retain the positioning of the optical element, additionally, fixating sticks 35, 36 are embodied between the outer support and the elastic elements 34.

The bearing elements 30, 32 shown in FIG. 6a are embodied in that way and permit high mobility of the inner mount 29 and therefore of element 28 with regard to the barrel or the support of the objective when the inner ring 29 is distorted so as to realize a statically defined bearing of each of the intermediate ring 31 and the inner ring 29,

Instead of intermediate ring 31 as shown by FIG. 6a, in the alternative, intermediate elements 37 (FIG. 6b) that, for instance, have a rectangular form in the top view may be employed together with bearing elements 38, 39. The bearing elements 38, 39 are symmetrical with regard to the radial axis of the optical element 28, the intermediate elements 37 and the barrel of the objective. Thereby, bearing element 39 is realized in that way that it embodies a statically defined bearing of inner ring 29. The bearing element 38 may be considered as a stiff spherical joint that may be distorted about all axes with respect to a rotation.

The optical element 28 may be tilted even in an easier way when bearing elements 40, 41 (FIG. 6c) are positioned in the region of the outer edges directed to the inner mount 31 or the outer mount, each shifted with respect to the radial axis of intermediate elements 42 in the region of the outer edges that are facing the inner mount 31 and the outer mount, respectively. The intermediate elements 42, preferably, have a form wherein the edge faces the inner mount 31 and the edge faces the outer mount 33 have a curvature that, preferably, corresponds to that of the inner mount 31 and to that of the outer mount. The bearing elements 40, 41 are assembled in a way analogous to that of the bearing elements 38, 39.

According to another embodiment (FIGS. 7a, b) intermediate parts 43 are provided between the inner mount 31 and the outer mount 33 that are assembled substantially as the intermediate parts 42 (FIG. 6c). Apart from bearing elements 40, 41 positioned in a shifted arrangement and as provided according to FIG. 6c elastic sticks 44 are provided. Thereby, movements of the inner mount 31 with regard to outer mount 33 are generated by distortion of the intermediate elements 43, 46. The distortions are realized by distortion of elastic sticks 45 according to the embodiment shown in FIG. 7a.

In an alternative embodiment (FIG. 7b) an intermediate element 46 is distorted by a bracket or a clamp 47 that is bent according to FIG. 7c. In both of the embodiments shown in the end, no resulting forces or moments are exerted on the distorted intermediate element 43 or 46, respectively.

FIG. 8a shows the classic lever principle in the example of a two-arm-lever 48 that is borne at a rotation point 49. Thereby a purely geometric correlation is given. Thus the work arm V2 as a function of the lever arm of the force:

V2=d×V1.

When elastic materials are applied for such a lever having two arms or only a single arm wherein the spring rigidity of the lever arm of the force is c1 (FIG. 8b) and wherein the spring rigidity of the work arm is c2 the reduction or transmission changes from V2=d×V1 to V2=c1/(c1+c2)×V1. Herein a transmission or a reciproque transmission (reduction) depends on the stiffness of the constructive elements; this can, by instance, mean:

c2=100×c1.

This principle is known and is, for instance, realized by a Michelson spring. When considering the energy balance of the assembly shown in FIG. 8b the work stored in the elastic elements is reciprocal to the stiffness of the elements. This means that a spring that in a spring that is a hundred times stiffer only a hundredth part of the total work exerted by the force may be stored. According to the invention, this principle of controlling force and rigidity is applied to the mount of an optical element. Embodiments of the invention are realized according to the principle of the cardanic joint or hinge (FIG. 1-4); in the same way embodiments comprising concentric rings are realized. In the first case a spring having a rigidity c2 is realized by the cardanic hinge, in the second case by the stiffness of the intermediate ring 27 (FIG. 5), 31 (FIG. 6a) or by the stiffness of intermediate parts 37 (FIG. 6b), 42 (FIG. 6c).

A spring having a stiffness c1 may be a thin wire, a spiral spring or a torsion spring (bracket 47) (FIGS. 7b, c) to bend the cardanic joint or in the alternative the intermediate ring or the intermediate parts. In this case, both ends of the spring attack at the middle ring a bend it in the region of attack. In a cardanic the spring that may be a torsion spring is tensioned from the outer ring in radial direction to the inner assembly of the optical element.

By “optical element” mentioned heretofore, the optical element itself or its flange is meant. According to the invention and throughout herein, whenever a soft mount or its component is said to be of low stiffness or less rigid, it is to be understood that the stiffness or rigidity is being compared with that of the position defining mounts for the optical element.

In another embodiment of the invention (FIG. 9a -c), instead of the adjusting mechanisms 10 as shown by FIG. 4, three elastic tunable elements 100 are provided at 120°-pitch regular intervals on the outer circumference of support member 22 and thereby permit adjusting the optical element 23 in two degrees of freedom by each of the elements 100.

Each of the elements 100 includes a first flat spring or leaf spring 101 and a second flat spring or leaf spring 102. The first flat spring 101 is bendable in the radial direction of the lens 23 and is connected to the support member 22 and the second elastic spring 102. The first spring 101 generates a first elastic force from a second elastic force applied by the second elastic spring 102 and applies the first elastic force to the support member 22.

The spring 102 bends in the radial direction when a force is applied on it by compression members 103 and 104 that are realized as micrometer screws and that are borne by the outer ring 19 (cf. FIG. 2).

Then spring 102 applies a compression force to the other spring 101 by a small bridge 105 connecting the springs 101, 102. A compression force is applied by members 103 and 104 if they both are rotated in the same sense of rotation to move the optical element 23 in radial direction.

If, however, the members 103, 104 are rotated in an opposite sense with respect to each other, a moment force or torque is applied to the spring 101 and is transferred to the other spring 102. Thereby, the ring 22 bearing optical element 23 is moved in the direction tilted with respect to the optical axis (the z-axis). Instead of compression members 103, 104 tension members may be inserted at the same positions that exert a tension on the spring 102 to be transferred to the optical element 23 by means of the spring 101. The members 103, 104 are inserted in insertion holes in the ring 19 or in a lens barrel. They are disposed at equal distances from a middle fiber 106 of spring 102.

In an alternative embodiment (FIG. 9b) the members 103, 104 are replaced by elastic rods 107, 108 that apply each a moment to the spring 102. The rods 107, 108 are borne in an insertion hole of ring 19. An adjusting force is applicable to the rods 107, 108 by tuning or adjusting mechanisms 109, 110 to turn them in a direction A. In another embodiment rods 107,108 may both be turned in the same direction B to exert a tangential adjustment of the element 23. If, however, rods 107, 108 are tensioned in an opposite direction B a rotational movement about a radial axis of optical element 23 is exerted (third degree of freedom).

In another embodiment of the invention (FIG. 10) a clamping mount 200 rigidly holds an optical element 201. Clamping mount 200 is isostatically borne by a bipod structure 202 comprising a hinge member 203. Leaf springs 205, 206 serve to apply a static moment to the mount 200.

However, according to the invention, the bearing member 202 permits an adjustment of the optical element 201 in at least two degrees of freedom. Therefore, at least a single lever arm 208 is provided that applies a moment in a direction C or in a direction D to a bearing member 202. This permits the bearing member 202 having solid body hinges or sufficient elasticity to be rotated about at least two non-parallel rotational axes, thus positioning the optical element 201 without exerting any actuating force or any actuating moment onto the optical element 201 by means of the mount 200.

According to another embodiment an optical element 300 (FIG. 11) is positioned on a resilient mount 301. The mount 301 is attached to an inner ring 302 that is connected to an intermediate ring 303 by a hinge or bearing arrangement 304 or to a bearing element holding the inner ring 302.

The intermediate ring 303 is connected to an outer ring 305 by another bearing element 306. Bearings 304 and 306 may be cardanic elements and/or isostatic elements wherein the intermediate ring 303 is a connecting element between the inner ring 302 and the outer ring 305 that it permits positioning of the optical element in at least two degrees of freedom. A gear box 307 according to the invention is applied between the inner and the outer ring 302, 305. The gear box 307 exerts a deformation of the intermediate ring 303, whereby the inner ring 302 is adjusted in its position with regard to the outer ring 305.

An additional element 309 applied to the inner ring 302 is adjustable by an actuator 310, e. g. a voice coil actuator, by an electrostrictive element or other means that correct imaging errors, for instance a pneumatic or hydraulic means. Thereby the resilient mount 301 is adjusted. Hereby a deformation of the optical element 300 may be realized to corrected any imaging errors of element 300. This embodiment provides for arranging multiple waveforms of the light to be exposed by the exposure apparatus.

1. An assembly for positioning of an optical element with respect to a mount, wherein
said optical element is positionable by a positioning arrangement, wherein
said positioning arrangement comprises at least a single elastic means that one of shifts and moves said optical element in two degrees of freedom independently by exerting one of a force and a torque on one of the optical element itself, a flange of said optical element, a holder enclosing said optical element and a support enclosing said optical element.

2. The assembly of claim 1, wherein
one of said holder and said support comprises at least a single isostatic mount to which one of a force and a torque is applied by said elastic means wherein
said isostatic mount is adjustable in at least two degrees of freedom.

3. The assembly of claim 2, wherein
said at least one isostatic mount is one of a bipod and a bipod structure.

4. The assembly of any of claim 1, wherein
said elastic means comprises one of a reduction means, a spring, an elastic lever an elastic rod, an elastic tape, an elastic belt, an elastic gear-wheel and an elastic wheel.

5. The assembly of claim 1, wherein
said elastic means is one of moveable and shiftable in each of said two degrees of freedom one of by two separate means, by two piezoelectric actuators, by two electostrictive actuators, by two motors, by two pneumatic means and by two hydraulic means.

6. The assembly of claim 1, wherein
three elastic means are provided that each are one of shiftable and moveable in two degrees of freedom.

7-13. (canceled)

14. An assembly for one fixation an adjusting of an optical element with regard to one of an outer mount and a support, wherein
said optical element is alignable with regard to one of a structure of an optical arrangement, an objective structure, an objective barrel having an optical axis and neighbouring mounts by means of an adjusting arrangement,
said adjusting arrangement comprises at least one of an elastic means a spring, an elastic rod, an elastic stick, an elastic tape, an elastic gear wheel and an elastic gear box by which one of a force and a torque is applicable to said optical element.
said optical element is positioned in an inner mount and one of said force and said torque for adjusting of said optical element is applied to said inner mount.

15. (canceled)

16. The assembly according to claim 14 wherein
said inner mount is connected to said outer mount by means of at least one intermediate part.

17. The assembly according to claim 16, wherein
said at least one intermediate part comprises a first bearing element connected to said inner mount, an intermediate element and at least one adjusting means by which one of a force and a torque is applicable for one of adjusting and positioning of said optical element by means of an elastic attacking means.

18. The assembly according to claim 17, wherein
said elastic attacking means comprises one of an elastic rod serving as a lever arm of a force in a lever, an elastic tape for transmission of a torque by means of at least one roll, an elastic gear wheel in a reduction gear for transmission of a torque, any elastic means transmitting a force onto said intermediate element, a spring transmitting a force onto said element, a spiral spring transmitting a force onto said intermediate element, and an elastic tape for transmitting a force onto said intermediate element.

19. The assembly of claim 18, wherein
said intermediate element is rigid or stiff and at least less elastic than said attacking means.

20. The assembly of claim 14, wherein
at least a second bearing element is provided, said second bearing element being connected to said outer mount.

21. The assembly of claim 17, wherein
said at least one adjusting means comprises at least one elastic lever attached to said intermediate element by one of its distal ends.

22. (canceled)

23. (canceled)

24. The assembly of claim 21, wherein
said at least one lever is connected at its second distal end with at least one of a fixation element, an element comprising at least one holes defining a predetermined position, an actuator and an adjustor.

25. The assembly according to claim 24, wherein
said actuator comprises one of an electromagnetic actuating means, an electrostrictive actuating means, a magnetostrictive actuating means, a pneumatic actuating means, a hydraulic actuating means and a mechanic actuating means.

26-36. (canceled)

37. An assembly for one of fixation, adjusting and or positioning of an optical element with regard to an outer mount, wherein
said optical element is one of alignable and positionable with regard to one of a structure of an optical assembly, a barrel of an objective having an optical axis neighbouring mounts and neighboring supports
the positioning or adjusting means is embodied by an intermediate ring positioned between said optical element and said outer mount.

38. The assembly according to claim 37, wherein
said optical element is received in an inner mount and
said intermediate ring is borne between said inner mount and said outer mount.

39. The assembly according to claim 37, wherein
adjusting means or actuators are arranged at said intermediate ring.

40. The assembly according to claim 37, wherein
at least one of a bearing elements of said assembly, a ring segment of said assembly and said intermediate ring is generated by eroding.

41. The assembly according to claim 40, wherein
one of said positioning means and said adjusting means comprises at least a single elastic element that is installed under tension in one of said intermediate ring and said ring segment and
one of said positioning means and said adjusting means applies one of two forces and torques being in equilibrium.

42. The assembly according to claim 41 wherein
one of said positioning means and said adjusting means comprises at least an elastic element that applies one of a force and a torque to said intermediate ring by application of a torsion to said elastic element.

43. The assembly according to claim 42, wherein
one of said torque and said force is applied to said intermediate ring by means of one of at least one reduction element, and a projection in the form of a block.

44. An assembly for one of fixation and adjusting of an optical element with regard to one of an outer support and a mount, wherein
said optical element is alignable with regard to one of a structure of an optical assembly, a structure of an objective, having an optical axis and a neighbouring mount by means of at least one adjusting arrangement
the at least one adjusting arrangement comprises an elastic element to which one of a force and a torque is applied.

45. The assembly according to claim 44, wherein
said optical element is positioned in one of an inner mount and an inner ring.

46. (canceled)

47. An adjusting assembly comprising an arrangement for one of moving and shifting one of an optical element and a support one of enclosing and supporting an optical element, wherein
said arrangement comprises one of at least a single mechanic transmission and a single mechanic reduction arrangement having a work arm supporting an optical element of a microlithographic exposure apparatus and a lever arm
at least one of said arms is at least one of made of an elastic material and is linked to an elastic means for transmitting a force.

48. (canceled)
